(19) United States
(12) Patent Application Publication
(10) Pub. No.: US 2015/0242372 A1
(43) Pub. Date: Aug. 27, 2015

(54) SYSTEM, APPARATUS AND METHOD FOR LAYOUT OF INFORMATION FROM DIFFERENT CONTENT SOURCES ONTO A PAGE

(71) Applicant: Tomoki Hattori, Suwanee, GA (US)

(72) Inventor: Tomoki Hattori, Suwanee, GA (US)

(73) Assignee: RICOH COMPANY, LTD., TOKYO (JP)

(21) Appl. No.: 14/187,552

(22) Filed: Feb. 24, 2014

(51) Int. Cl. G06F 17/21; G06F 3/12; G06K 15/02; G06F 17/22; G06K 15/00

(52) U.S. Cl. CPC G06F 17/212; G06F 17/2294; G06K 15/007; G06K 15/181; G06F 3/1286; G06F 3/125; G06F 3/1204; G06F 3/1206; G06F 3/1236

(57) ABSTRACT

tools (for example, a system, an apparatus, application software, a method, etc.) can be provided to allow a user of a terminal apparatus to assemble information from different content sources information onto a single layout page.

### TECHNICAL FIELD

This disclosure relates to systems, apparatuses, methodologies, computer program products, etc., for aiding users in combining information from different content sources onto a single page.

### BACKGROUND

In the current digital age, the trend is that more and more tasks involve use of information technology (IT) and digital media. Due to the proliferation of IT and other technologies, as well as changes in our society to ever higher levels of mobility, expectations of access to information while on-the-go is becoming part of the current day culture. Consequently, virtually every individual in our society carries one or more mobile devices (such as tablet or notebook computers, smartphones and other handsets with a display, etc.) to facilitate such access.

The ever more sophisticated mobile devices allow users to access information via any of various media. For example, e-mail and messaging are popular means to communicate information, such as when an oral conversation is not possible, convenient, suitable, etc., as well as in other circumstances. Further, the web provides a whole world of available content and information. In addition, software applications running on the mobile devices may allow the user to access content or information through the Internet and/or another data network.

However, it may be difficult to view, on a display of the mobile device, information from multiple content sources, although information may be viewed from one source at a time. In such instance, the user needs the functionality to switch from one page to another (and back) quickly.

Thus, there is a need for a tool that allows the user to view information from multiple sources efficiently, and even concurrently, via a mobile device.

### SUMMARY

Various tools (for example, a system, an apparatus, application software, a method, etc.) can be configured to enable a user of a mobile device, particularly one with a relatively smaller display area, to assemble information from multiple content sources onto a single page. Thus, such information from multiple content sources can be efficiently output, without printing each page of the multiple content sources onto a separate printed page.

Such tools can have a high level of utility in many instances. For example, there are many circumstances when a consumer might research various similar products and would like to consider the information of each product amongst multiple products side-by-side along with the information of the other products. Further, such consumer may wish to have such information handy when consulting a retail establishment. It is far easier to have one sheet that includes the relevant information for the multiple products than to have a separate printed document (bearing information of little significance to the particular consumer, as well as the relevant information) for each product.

Such tools may be configured in any of many different ways, but preferably is easy to use on a mobile device (such as, for example, a smartphone or tablet computer), a kiosk, etc. For example, such a tool may be provided via programming (such as a print application) on a terminal apparatus to provide a layout interface including a frame content part to receive a user-specified frame command to frame a portion of a content page, and a corresponding module of the layout interface, in response to the frame command, causes a user-manipulatable frame to be displayed on a graphical display of the terminal (e.g., a size of, and a location to place, the user-manipulatable frame on the graphical display may be based on tags in the content page, content in the content page, etc.), while the layout interface permits the displayed frame to be moved and to be resized by the user. Further, the layout interface includes a capture part to receive a user-specified capture command, and in response to such command, a corresponding module of the layout interface the framed content page portion to be captured into a capture buffer. The layout interface also includes a place content part to receive a user-specified place command, and in response to such command, a corresponding module of the layout interface retrieves the captured content page portion from the capture buffer and places the captured content page portion onto a layout page in progress.

In another aspect, the captured content page portion can be placed by the layout interface onto the layout page in progress with another user-manipulatable frame surrounding the placed content page portion, and in such case, the layout interface permits the user to move and resize such other frame surrounding the placed content page portion. On the other hand, the user may be provided with the selectable option that when the user resizes such other frame surrounding the placed content page portion, text in the content page portion surrounded by said another frame is correspondingly resized as well. In any event, such other frame surrounding the placed content page portion may, at least when initially placed on the layout page in progress, be the same size as that of the user-manipulatable frame surrounding the content page portion when the content page portion was captured.

In another aspect, the layout interface can further include a job submit part to receive a user-specified submit command to finalize the layout page in progress and submit the finalized page as a print job, or to capture it as a finalized page that can be captured for printing at a later time. In addition, the user may be provided with the selectable option that when the job submit part receives the user-specified submit command to finalize the layout page in progress, the layout interface automatically resizes content page portions placed on the layout page in progress to minimize an unused portion (i.e. portion having no content placed therein) of the layout page in progress.

In another aspect, when the place content part receives the user-specified place command to place another captured content page portion onto the layout page in progress, the corresponding module of the layout interface automatically determines an unused portion (i.e. portion having no content placed therein) of the layout page in progress, and places said another content page portion in said unused portion of the layout page in progress.

The aforementioned layout interface may be embedded in application software, such as a print application. Such application may be provided on any of various terminals, such as a kiosk (including printer or plotter), a multi-function device, a mobile terminal, etc. Such print application may be provided as a native client or as software as a service (SaaS) via a network from an application server or another application providing apparatus (such as via a peer-to-peer arrangement), to allow a user of the terminal to assemble information from multiple content sources onto a single page to be printed.

In another aspect of this disclosure, a print layout method may include one or more of the following:

providing a layout interface including a frame content part to receive a user-specified frame command to frame a portion of a content page;

causing a user-manipulatable frame to be displayed, in response to the frame command, and providing handles on the displayed frame for the user to move and to resize the frame;

receiving a user-specified capture command and capturing the framed content page portion into a capture buffer;

receiving a user-specified place command, and retrieving the captured content page portion from the capture buffer and placing the captured content page portion onto a layout page in progress with another user-manipulatable frame surrounding the placed content page portion;

providing handles on said another frame surrounding the placed content page portion to permit said another frame surrounding the placed content page portion to be moved and to be resized by the user;

providing another user-manipulatable frame surrounding the placed content page portion on the layout page in progress, and permitting said another frame surrounding the placed content page portion to be moved and to be resized by the user;

resizing text in the content page portion surrounded by said another frame correspondingly, when the user resizes said another frame surrounding the placed content page portion;

providing a job submit part in the layout interface to receive a user-specified submit command to finalize the layout page in progress and submit the finalized page as a print job;

automatically resizing content page portions placed on the layout page in progress, when the job submit part receives the user-specified submit command to finalize the layout page in progress, the layout interface, to minimize an unused portion of the layout page in progress;

receiving the user-specified place command to place another captured content page portion onto the layout page in progress, automatically determining an unused portion of the layout page in progress, and placing said another content page portion in said unused portion of the layout page in progress;

determining a size of, and a location to place, the user-manipulatable frame on the graphical display, based on tags in the content page, content in the content page, etc.

### BRIEF DESCRIPTION OF THE DRAWINGS

The aforementioned and other aspects, features and advantages can be more readily understood from the following detailed description with reference to the accompanying drawings wherein:

FIG. 1 shows a block diagram of a mobile terminal apparatus configured to allow a user to assemble information from multiple content sources onto a single page, in accordance with an exemplary embodiment;

FIG. 2A shows a block diagram of a system in which a mobile terminal apparatus is provided with a print application configured to allow a user to assemble information from multiple content sources onto a single page, in accordance with an exemplary embodiment;

FIG. 2B shows a block diagram of a system in which a mobile terminal apparatus is configured to allow a user to assemble information from multiple content sources onto a single page and submit such page for printing, in accordance with an exemplary embodiment;

FIG. 3 shows a block diagram of an exemplary configuration of a computing device;

FIG. 4 shows a block diagram of an exemplary configuration of a mobile terminal apparatus;

FIG. 5 shows a block diagram of an exemplary configuration of a multi-function device;

FIG. 6 shows a flow chart of a method performed by a print application or a mobile terminal apparatus, in accordance with an exemplary embodiment;

FIGS. 7A-7H show respective examples of user interface screens provided by a print application or a mobile terminal apparatus, in accordance with an exemplary embodiment;

FIG. 8 shows a flow chart of a method performed by a print application or a mobile terminal apparatus, in accordance with an exemplary embodiment;

FIGS. 9A-9G show examples of user interface screens provided by a print application or a mobile terminal apparatus, in accordance with an exemplary embodiment;

FIG. 10 shows a flow chart of a method performed by a print application or a mobile terminal apparatus, in accordance with an exemplary embodiment;

FIGS. 11A-11B show examples of user interface screens provided by a print application or a mobile terminal apparatus, in accordance with an exemplary embodiment;

FIG. 12 shows an example of HTML code that can be used for creating a layout page;

FIG. 13 shows a flow chart of a method performed in the system of FIG. 2B, according to an exemplary embodiment; and

FIGS. 14A-14B show examples of user interface screens provided by a print application or a mobile terminal apparatus, in accordance with an exemplary embodiment.

### DETAILED DESCRIPTION

In describing preferred embodiments illustrated in the drawings, specific terminology is employed for the sake of clarity. However, this disclosure is not intended to be limited to the specific terminology so selected and it is to be understood that each specific element includes all technical equivalents that operate in a similar manner. In addition, a detailed description of known functions and configurations is omitted when it may obscure the subject matter of the present invention. Referring now to the drawings, wherein like reference numerals designate identical or corresponding parts throughout the several views, there are described tools (such as systems, apparatuses, methodologies, computer program products, etc.) for a print layout tool.

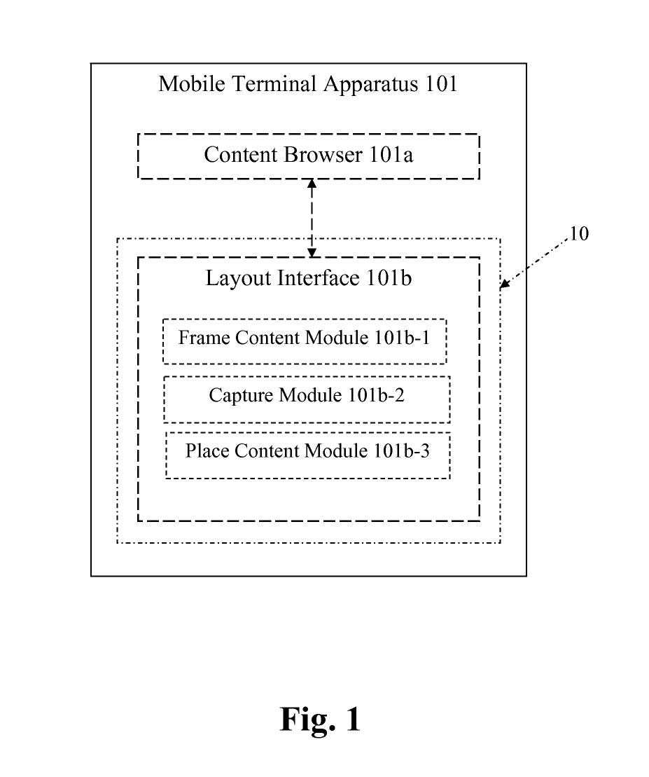

FIG. 1 shows schematically a block diagram of a mobile terminal apparatus 101 which includes a content browser 101a and is configured by programming 10 (such as a print application or other software) to include a layout interface 101b.

The mobile terminal apparatus 101 can be any computing device, including but not limited to a personal, notebook or workstation computer, a kiosk, a PDA (personal digital assistant), a mobile phone or handset, another information terminal, etc., that can communicate with other devices through the network 104. The mobile terminal apparatus 101 is further described infra with reference to FIG. 4.

The content browser 101a retrieves content from a network and displays it to the user through a graphical display on the mobile terminal apparatus 101. The content may be from a variety of sources which may be obtained via the internet, an app, through a file transfer protocol (FTP), e-mail, text messaging, etc. Further, the content displayed by the content browser 101a may be in the form of text (i.e. articles, blogs, digital books, text messaging, etc.) or images (jpeg, bmp, png, tiff, etc.).

The layout interface 101b provides the user with the ability to place different portions of content shown in the content browser 101a onto a single layout page. The layout interface 101b is comprised of a frame content module 101b-1, a capture module 101b-2 and a place content module 101b-3. The frame content module 101b-1 creates a frame around a portion of the content page currently being displayed by the content browser 101a after receiving a request from the user to do so. The frame may be in the shape of a thin outline that can be any color (black, white, blue, red, green, yellow, etc.) or shape (rectangle, triangle, circle, star, etc.). Further, the modules composing the thin outline may be in different shapes and patterns as well (dashed, dotted, long dash & dotted, etc.).

After the user is satisfied with the size and shape of the frame around a portion of the content page, the user may authorize the capture module 101b-2 to capture the content page portion that has been framed by the user. Next, the capture module 101b-2 may place the captured content page portion onto a capture buffer. The capture buffer may be implemented via software by using a data buffer which points to a location in a RAM in the mobile terminal apparatus 101 to store the captured content page portion or through a physical storage medium, such as a hard disk drive. Then, the user may select a layout page to place the captured content page portion currently stored in the capture buffer. After doing so, the place content module 101b-3 retrieves the captured content page portion from the capture buffer and places it on to the layout page selected by the user. In addition, to placing the captured content page portion on to the layout page, the place content module 101b-3 also allows the user to manipulate the captured content page portion. For example, the place content module 101b-3 creates another frame around the captured content page portion which allows the user to resize or move it.

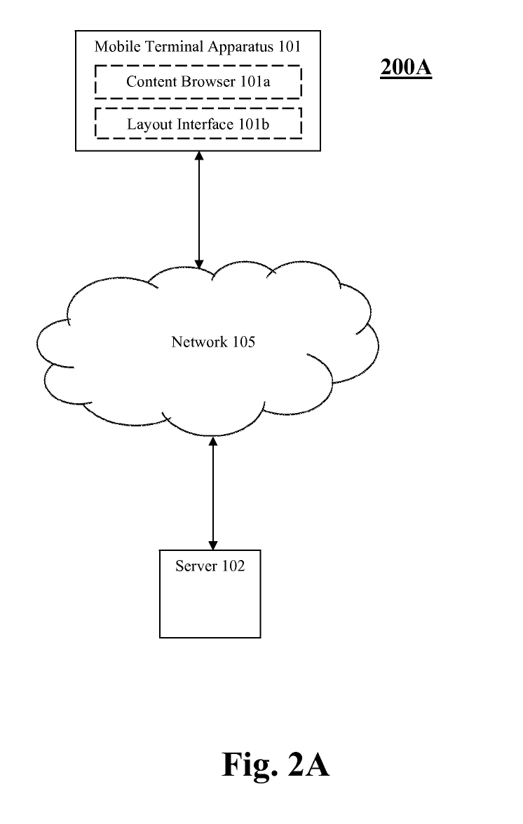

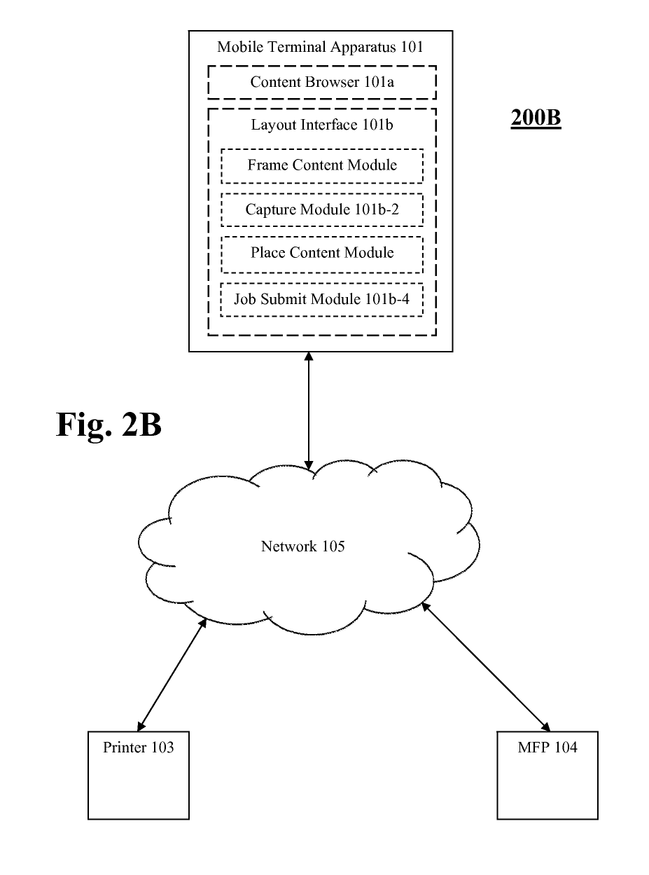

FIG. 2A shows schematically a system 200A that includes a mobile terminal apparatus 101 and a server 102, all of which are interconnected by network 105. Although only one mobile terminal apparatus is shown in FIG. 2A, it should be understood that the system 200A can include a plurality of user terminal devices (which can have similar or different configurations).

The server 102 is connected to network 105, and may provide features such as the content browser 101a and/or the layout interface 101b, on demand, to a requesting device, such as the mobile terminal apparatus 101. In such instance, such content browser 101a and/or layout interface 101b is not pre-installed on the mobile terminal apparatus 101 and is instead downloaded, or provided as a service, to the mobile terminal apparatus 101 from another location (e.g., the server 102). Thus, in the case in which the user wishes to access the content browser 101a and the layout interface 101b, the mobile terminal apparatus 101 may send a request to the server 102. In response to such request, the server 102 may provide the content browser 101a and the layout interface 101b to the mobile terminal apparatus 101. However, before sending the software the server 102 may check user credentials. If the user has authorization to access the content browser 101a and the layout interface 101b, the server 102 provides them to the mobile terminal apparatus 101. Otherwise, they are not provided to the mobile terminal apparatus 101.

The network 105 can be a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 105. In addition, the network 105 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

FIG. 2B shows schematically a system 200B, according to another exemplary embodiment. The system 200B is similar to the system 200A of FIG. 2A except that the mobile terminal apparatus 101 additionally comprises a job submit module 101b-4 and the system additionally includes a printer 103 and an MFP 104.

The terms “printer” and “printer device” are used hereinafter generically to include any output device having a printing or plotting functionality, and include multifunction devices having a copy and/or scanning functionality in addition to the printing or plotting functionality.

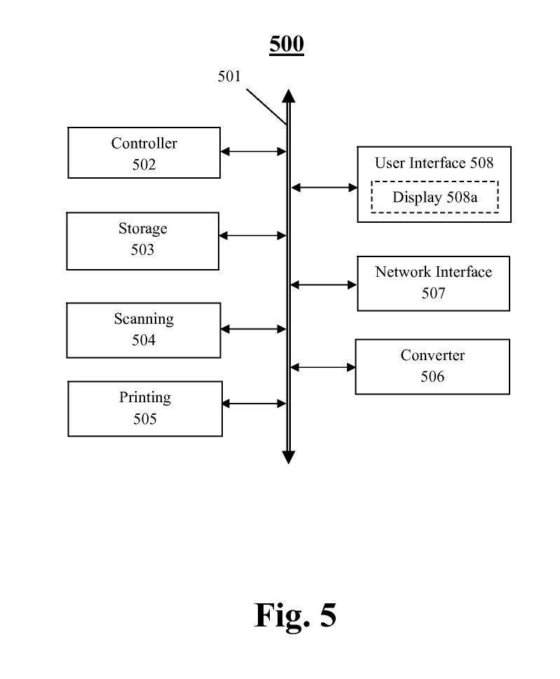

The MFP 104 can be, for example a printer/scanner, printer/scanner/fax, etc. While this example of this disclosure simply refers to a single MFP 104 and a single printer 103 in the interest of brevity, it should be appreciated that the network environment can have an arbitrary number of MFP and printer devices. The MFP 104 may be configured as shown in FIG. 5, which is discussed infra.

The job submit module 101b-4 provides the user with the ability to submit the layout page on the mobile terminal apparatus 101 as a print job. After the user has finalized the layout page, he or she is given the opportunity to submit the layout page to a printer (i.e. 103) or an MFP (i.e. 104). In case that the user wishes to print, the job submit module 101b-4 may cause the mobile terminal apparatus 101 to not only finalize the layout page but also perform resizing of the content page portions to minimize the amount of unused portions.

Otherwise, operations of the elements of the system 200B are similar to those discussed in connection with the corresponding elements of the system 200A of FIG. 2A.

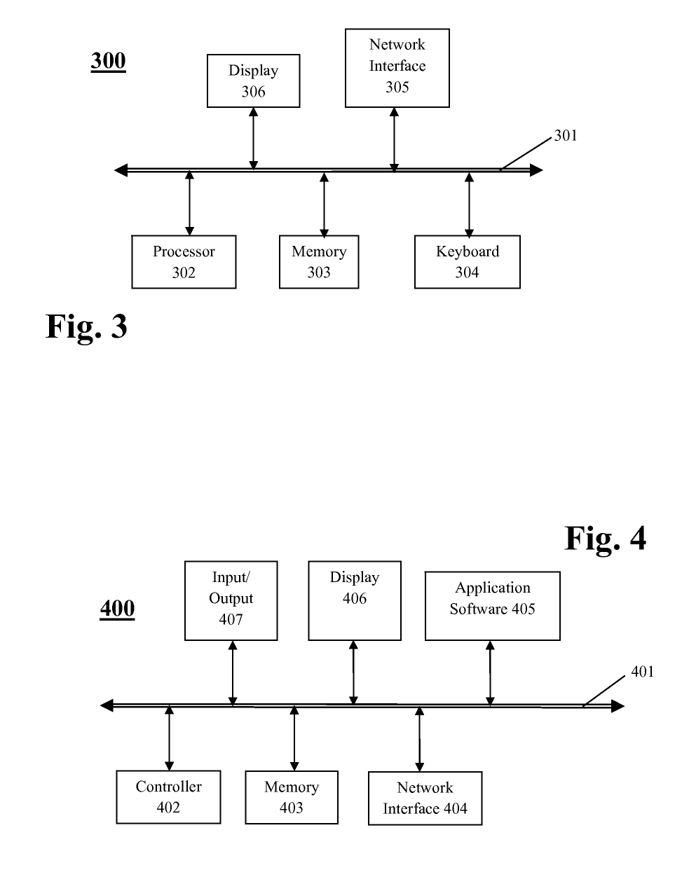

FIG. 3 shows an exemplary constitution of a computer 300 that can be configured (for example, through software) to operate (at least in part) as the server 102 of FIG. 2A. The computer 300 includes a processor (or central processing unit) 302 that communicates with a number of other components, including a memory or storage part 303, keyboard 304, network interface 305 and display 306, by way of a system bus 301. The computing device 300 may be a special-purpose device (such as including one or more application specific integrated circuits or an appropriate combination of conventional component circuits) or it may be software configured on a conventional personal computer or computer workstation with sufficient memory, processing and communication capabilities to operate as a terminal and/or server, as will be appreciated to those skilled in the relevant arts.

Additional aspects or components of the computing device 300 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

FIG. 4 shows an exemplary constitution of the mobile terminal apparatus 101 of FIGS. 1, 2A and 2B (for example, as a mobile computer). In FIG. 4, a mobile computer 400 includes a controller (or central processing unit) 402 that communicates with a number of other components, including memory 403, network interface 404, application software 405, display 406 and input/output (such as mouse, keyboard, touchpad, stylus, microphone and/or speaker with voice/speech interface and/or recognition software, etc.) 407, by way of an internal bus 401.

The memory 403 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 404 provides a connection (for example, by way of an Ethernet connection or other network connection which supports any desired network protocol such as, but not limited to TCP/IP, IPX, IPX/SPX, or NetBEUI) to the network to which the computer 400 is connected (e.g., network 106 of FIGS. 2A and 2B).

The application software 405 is shown as a component connected to the internal bus 401, but in practice is typically stored in storage media such as a hard disk or portable media, and/or received through the network, and loaded into memory 403 as the need arises.

Additional aspects or components of the computer 400 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

FIG. 5 shows a schematic diagram of a configuration of a printing device as an MFP (multi-function printer or multi-function peripheral), which can be any apparatus (including a microprocessor chip or a collection of devices having varying degree of integration) that has the ability to perform two or more functionalities.

The MFP 500 shown in FIG. 5 includes a controller 502, and various elements connected to the controller 502 by an internal bus 501. The controller 502 controls and monitors operations of the MFP 500. The elements connected to the controller 502 include storage 503 (for example, random access memory, read-only memory, hard disk drive, portable storage media drive such as for optical discs, magnetic discs, magneto optical discs, etc., semiconductor memory cards, combinations of storage media, etc.), scanning 504, printing 505, converter 506, a network interface (I/F) 507 and a user interface 508.

Storage 503 can include one or more storage parts or devices [e.g. a read only memory (for example, ROM, PROM, EPROM, EEPROM, etc.), a random access memory (RAM), a hard disk drive (HDD), portable media (for example, floppy disk, optical disc, magnetic discs, magneto-optical discs, semiconductor memory cards, etc.) drives], and program code instructions can be stored in one or more parts or devices of storage 503 and executed by the controller 502 to carry out the instructions. Such instructions can include instructions for performing specified functions (such as printing, scanning, faxing, copying, e-mailing, etc.) of the MFP 500, to enable the MFP 500 to interact with a terminal, as well as perhaps other external devices, through the network interface 507, and interactions with users through the user interface 508.

The network interface 507 is utilized by the MFP 500 to communicate with other network-connected devices such as a terminal or a server (e.g., the server 102 of FIG. 2A) and receive data requests, print jobs, user interfaces, and etc.

The user interface 508 includes one or more electronic visual displays that display, under control of controller 502, information allowing the user of the MFP 500 to interact with the MFP 500. The electronic visual display can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the MFP 500, so as to allow the operator to interact conveniently with services provided on the MFP 500, or with the MFP 500 serving as terminal for accessing electronic data or other content through the network. User interfaces or other contents received through the network via the network interface 507 can be displayed on the display screen.

The display screen does not need to be integral with, or embedded in, a housing of the MFD 500, but may simply be coupled to the MFD 500 by either a wire or a wireless connection. The I/O 508 may include keys and/or buttons (such as graphical keys or buttons, or other graphical elements, of a GUI on a touchscreen display) for inputting information or requesting various operations. Alternatively, the I/O 508 and the display screen 507a may be operated by a keyboard, a mouse, a remote control, voice recognition, or eye-movement tracking, or a combination thereof.

Scanning 504, printing 505, and network interface 507 are otherwise conventional, and therefore, a detailed description of such conventional aspects is omitted in the interest of clarity and brevity.

The MFP 500 can have any or all of the functions of similar devices conventionally known, such as for scanning, editing and storing images, sending a fax, sending and receiving e-mails with or without attachments, accessing files by FTP or another protocol or facility, surfing the Web, etc. Further, multi-functional devices or multifunction peripheral devices can play a prominent role to convert hardcopy documents to electronic documents.

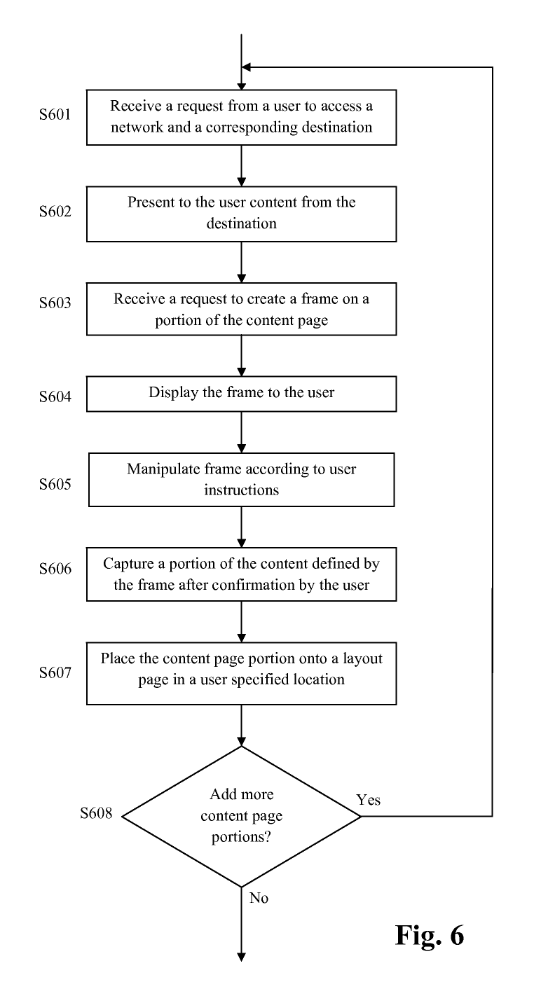

FIG. 6 shows a process performed by a mobile terminal apparatus (e.g., 101), for executing a print layout tool, according to an exemplary embodiment.

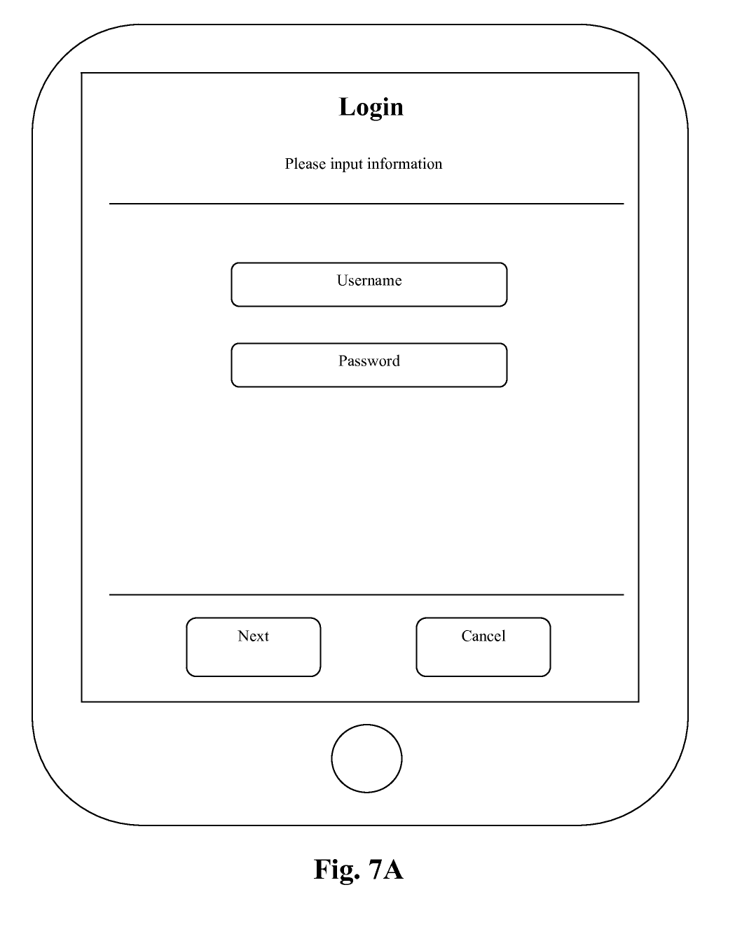

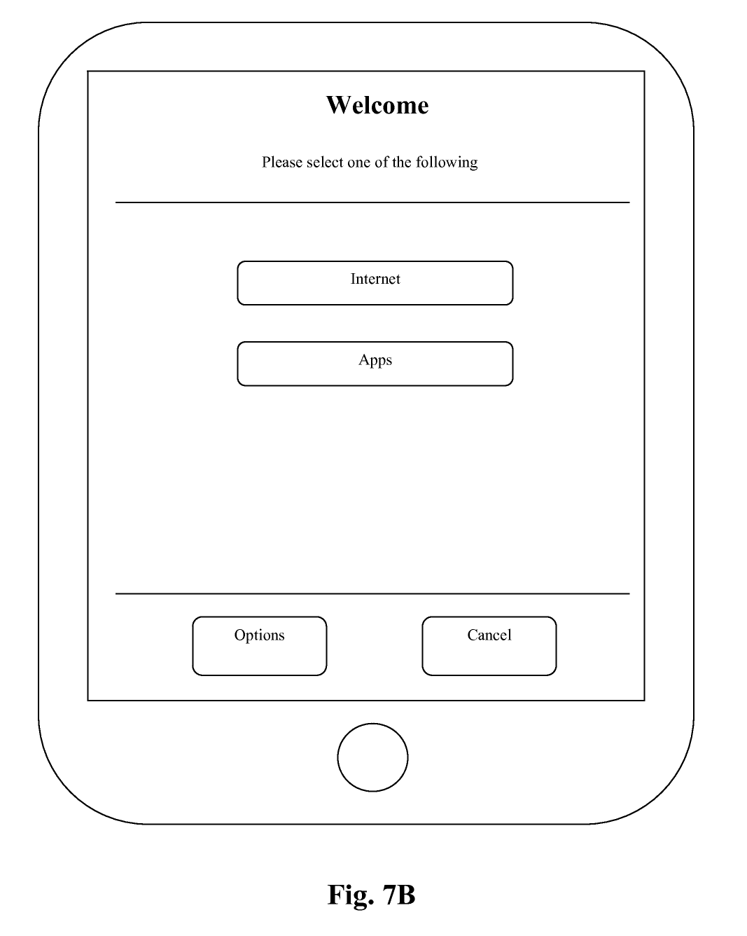

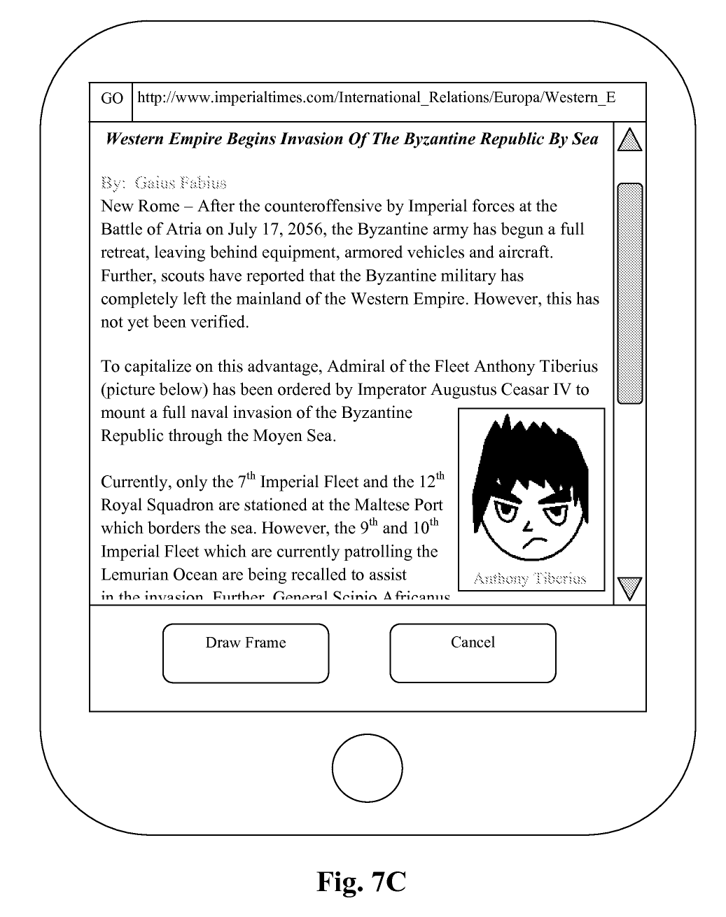

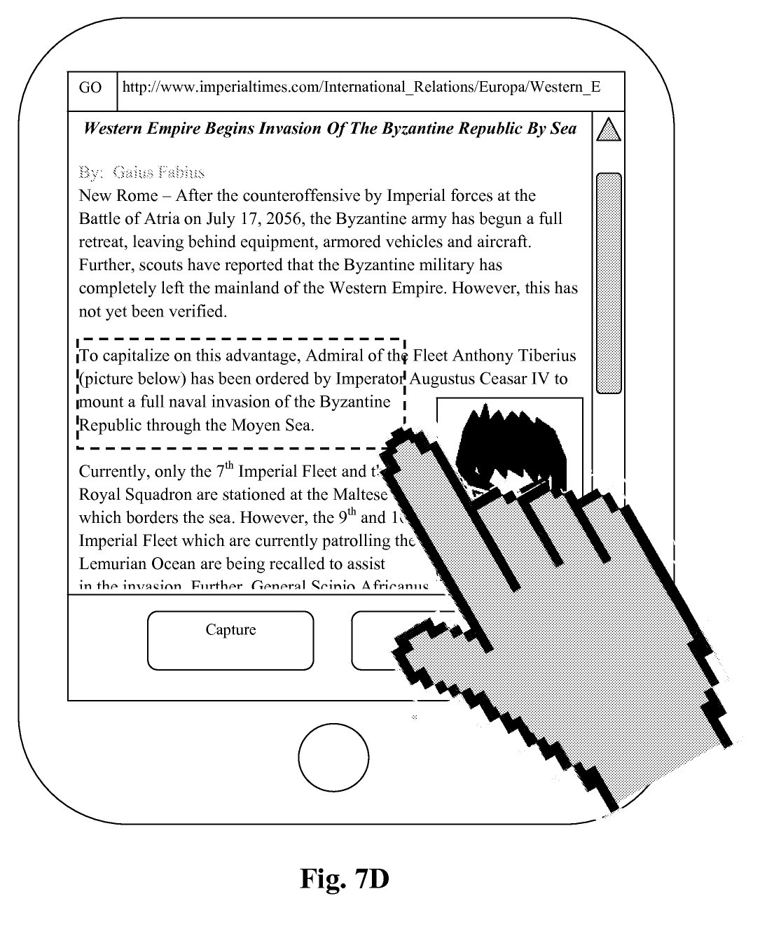

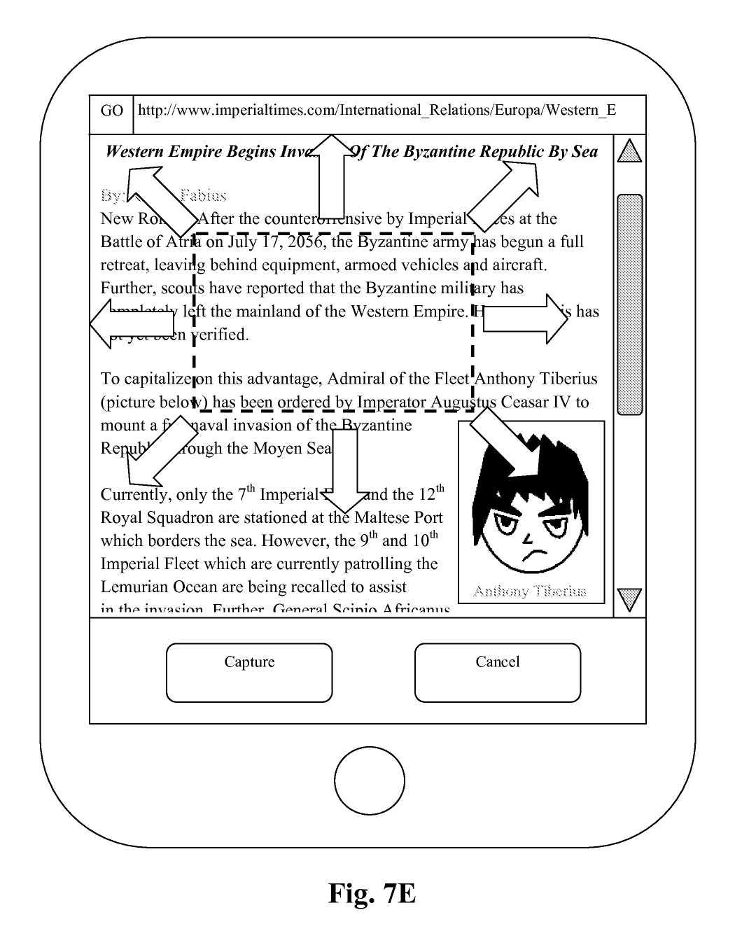

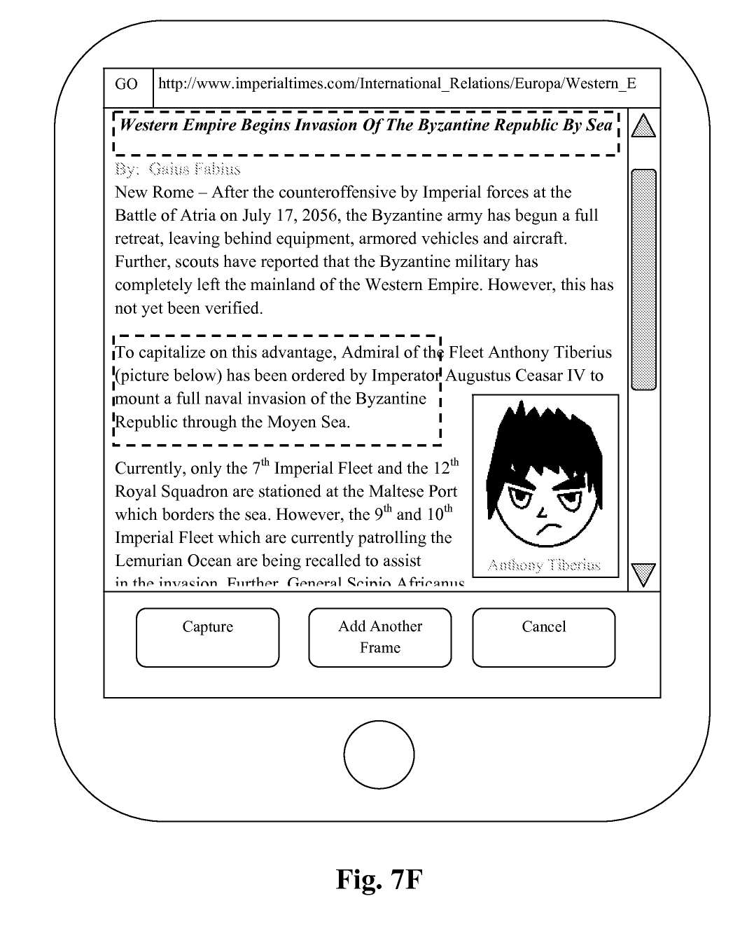

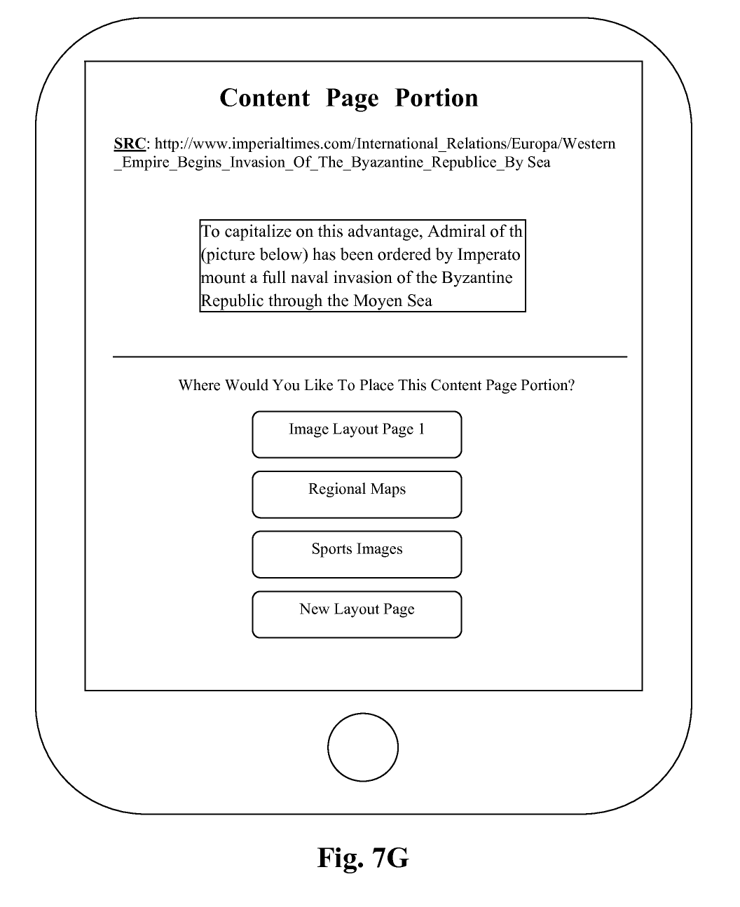

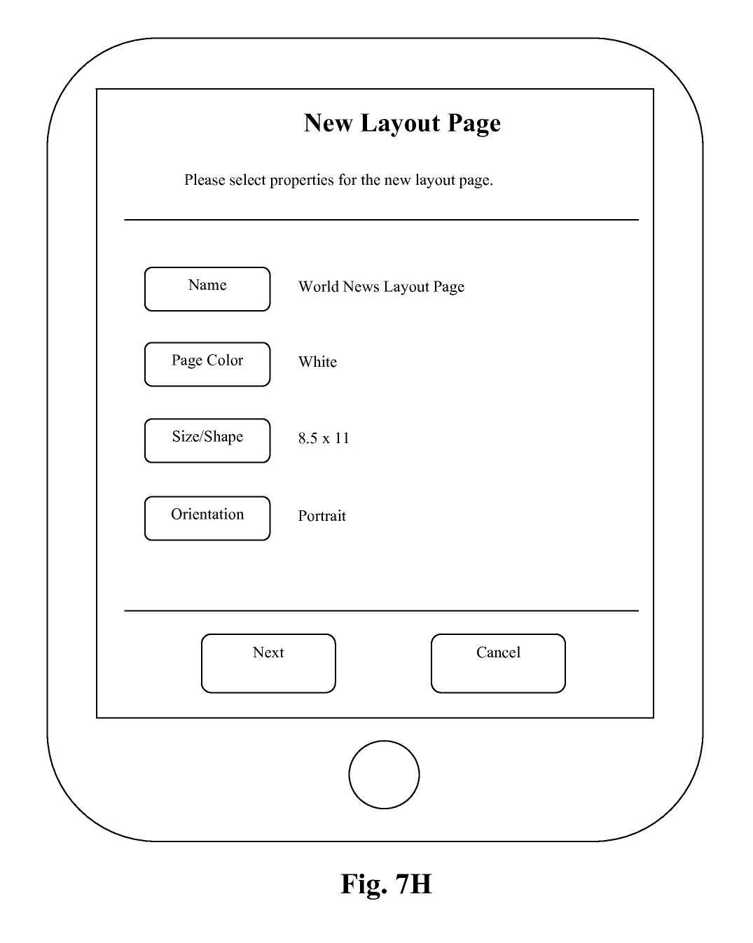

When a user wants to combine images and texts obtain from the network onto a single page for ease of view via the mobile terminal apparatus 101, the user first inputs user credentials to access the mobile terminal apparatus 101, as shown in FIG. 7A. It should be noted that the user credentials are not limited to the form of a username and password. For example, the user may use an ID card to perform the login, instead. After the mobile terminal apparatus 101 has verified the information sent by the user, the user is then presented with a list of sources (i.e. internet, apps) that the mobile terminal can access as shown in FIG. 7B. For example, the user may select to obtain content from the internet and may input a uniform resource locator (URL) into the mobile terminal apparatus in order to view a page corresponding to the URL. On the other hand, the user may also select a software app which was previously downloaded onto the mobile terminal apparatus 101. The app may be any type of software which may include, but is not limited to, displaying digital newspapers, electronic books, stock market updates, image sharing programs, etc. to the user. After receiving the request from the user to obtain content from the network and a corresponding destination (step S601), the mobile terminal apparatus 101 displays the content to the user (step S602), as illustrated in FIG. 7C.

As shown, the user has selected to view a page on the internet. In this case, the page is a newspaper article which includes both text and an image. Further, below the newspaper article, there is a “Draw Frame” button. This button allows the user to create a frame around a portion of the article. For example, the user may be compiling news articles on current events onto a single page for researching international relations. However, some of the information contained in each article may be superfluous and the user may desire only concise and pertinent information. Thus, the user may use the “Draw Frame” button (step S603) to create a frame that appears superimposed on the article (step S604), as shown in FIG. 7D. The frame, in this case, is a hollow rectangle with a visible dashed outline. However, it should be noted that the frame is not limited to being a shape of a rectangle. It may be a circle, oval, triangle or a star instead. Further, it is not necessary that the outline be a black-colored dashed line as it can be colored solid line as well.

Further, as shown, the user may also manipulate the frame via his or her fingers. The mobile terminal apparatus 101 may receive instructions from the user to move the frame to any location on the screen and/or modify its size as well (step S605). As shown in FIG. 7E, the user may increase or decrease the size of the frame by manipulating the frame according to the directions indicated by the arrows. For example, should the user desire to increase the height of the frame, he or she may touch the top part of the triangle with his or her finger and move in the direction of the “north” arrow. On the other hand in the case that the user desires to decrease both the height and the width of the frame, he or she may touch the bottom right corner of the frame and move in it in a direction opposite of the “southwest” arrow.

In an exemplary embodiment, the user may place more than one frame onto the article, as shown in FIG. 7F. The user may add another frame by pressing the “Add Another Frame” button which places a second frame superimposed on the article. Like, the first frame, the second frame can also be manipulated in the same manner. Further, the user may still manipulate the first frame even though the second frame is simultaneously superimposed on the article. In addition, the two frames may overlap each other. In the case that this happens, the portions of the articled defined by the two frames are not affected by the overlap. Each still shows the portion defined by the frame.

After the user is satisfied with the content page portion defined by the frame, he or she may proceed to capture the content page portion by pressing the “capture” button. When this occurs, the mobile terminal apparatus 101 proceeds to capture the content page portion and store it in a capture buffer (step S606). The capture buffer may be implemented via software by using a data buffer which points to a location in a RAM in the mobile terminal apparatus 101 to store the captured content page portion. However, the capture buffer may also be implemented through physical storage medium, such as a hard disk drive.

Simultaneously, the mobile terminal apparatus 101 also presents a screen to the user, as illustrated in FIG. 7G after the user presses the “capture” button. In the screen, the user is shown the content page portion previously captured and its source. In this case, the content page portion is a part of the news article and the source is its corresponding URL. It should be noted that if the content page portion came from an app or another source on the network, the source shown to the user reflects that.

For example, a newspaper company such as “Roman Financial Times” may offer services both on the internet via URL and through an app called the “RFT Mobile News”. Should the user capture the content portion from an article viewed on the “Roman Financial Times” app, the source may be shown to the user as “RFT Mobile News”. It should also be noted that the user may obtain content from neither the internet or through an app. For example, the user may be an editor who is receiving draft articles from a journalist who is currently reporting from a foreign country. To send the articles to the editor, the journalist may use a network protocol such as FTP. The source, in this case, may be ftp://journalist1@RFT.ftp-servers.com/directory/war_article.

Below the source and the captured content page portion the user may select a layout page previously created by the user to place the captured content page portion. As shown, the user may select from any existing layout page previously created by the user, which in this case are “Image Layout Page 1”, “Regional Maps” and “Sports Image”, to place the captured content page portion in. In addition, the use is also allowed to create a new layout page as well. He or she may proceed to facilitate this by pressing a “New Layout Page” button. In the case that the user presses the “New Layout Page” button, the mobile terminal apparatus 101 presents a screen to the user, as shown in FIG. 7H. Here the user has the opportunity to set the properties for the new layout page. For example, the user may select an identifier such as a name for future reference (in this case “World News Layout Page”). Further, he or she can set the size (i.e. 8.5×11, A4, B3, A3, etc.) or the shape (i.e. rectangle, triangle, circle, star, etc.) of the new layout page. In addition, the user may also change the color of the new layout page (white, green, black, blue, red, yellow, purple, etc) and change its orientation (portrait or landscape) as well. However, it should be noted that the properties shown in FIG. 7H should not be limited to name, size, color and contrast. For example, other properties may also include contrast (medium, light, dark), margins, water marks, page borders, themes, etc.

After the user has selected the properties corresponding to the new layout page, he or she may press the “Next” button to access the new layout page from which the captured content portion is automatically inserted into by the mobile terminal apparatus 101 (step S607). Afterwards, the user may opt to add another image to the new layout page (step S608). In the case that the user wants to add another image to the “World News Layout Page” layout page, the user may be taken back to the screen shown in FIG. 7B and may be allowed to select a new destination to obtain other content (step S608, yes). On the other hand, the user may be satisfied with the layout page and thus may move to the next process by pressing the “Next” button (step S608, no).

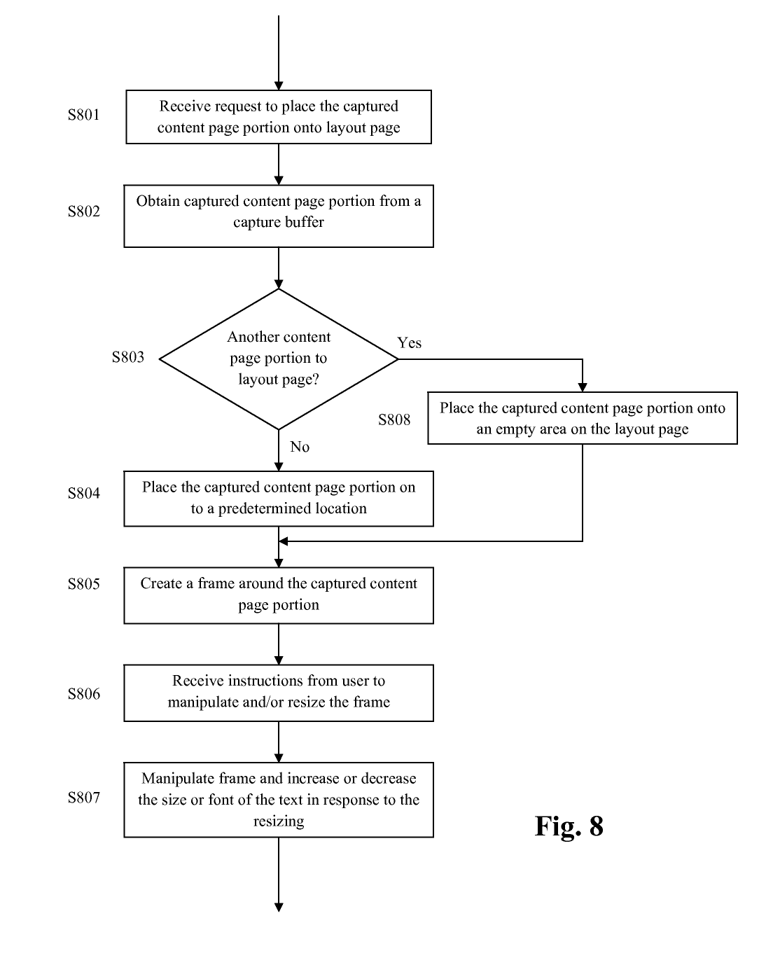

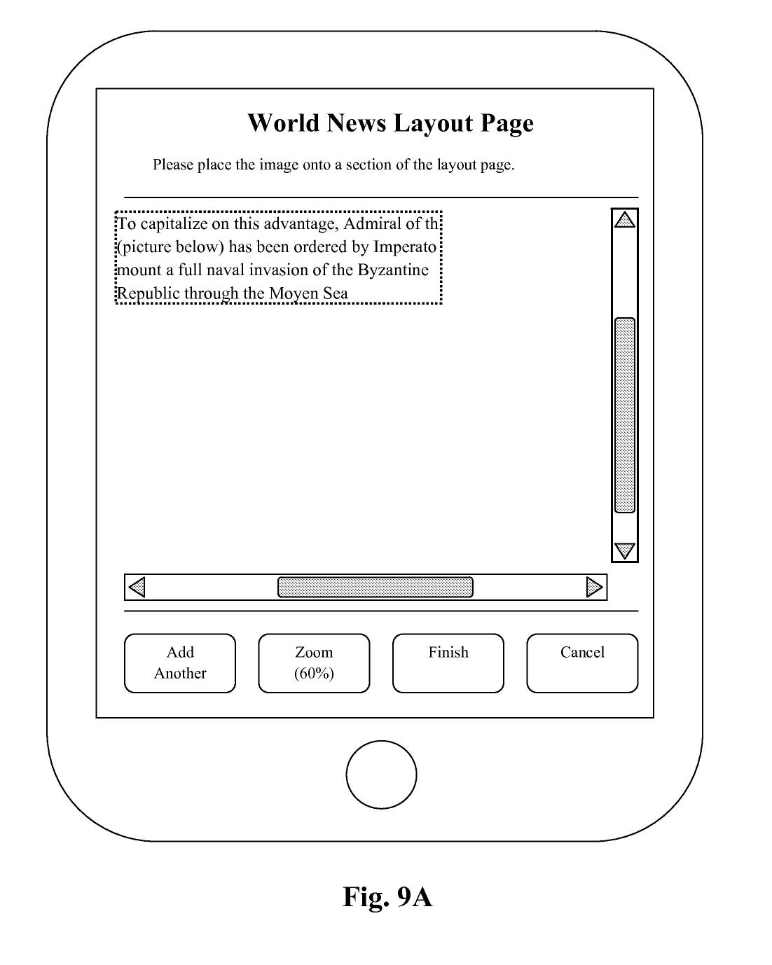

FIG. 8 shows a process performed by a mobile terminal apparatus (e.g., 101), for executing a print layout tool, according to an exemplary embodiment.

The user may manipulate the captured content page portion even further after it is placed onto the layout page. After the user has instructed the mobile terminal apparatus 101 to place the captured content page portion onto a layout page (step S801), and the desired content page portion is obtained from a capture buffer (step S802), the mobile terminal makes a determination of whether there is an existing content page portion in the layout page (step S803).

In the case that there is no existing content page portion (step S803, no), the mobile terminal apparatus 101 may place the captured content page portion onto a location on the layout page that was previously specified or in other words, a predetermined location (step S904). The location may be set initially in the mobile terminal 101 or the user. For example, the mobile terminal may be set to place the captured content page portion onto the upper most left area of the layout page or the user may want the captured content page portion to be on lower area of the layout page, instead. This feature allows the user with a starting point to better organize the subsequent captured content page portion (assuming that the user is putting more than one content portion to be on the layout page) that are to be on the layout page. Thus, after a particular layout page is selected by the user to place the captured content page portion in and the mobile terminal apparatus 101 determines the layout page is empty, the captured content page portion is placed on the page in a predetermined location.

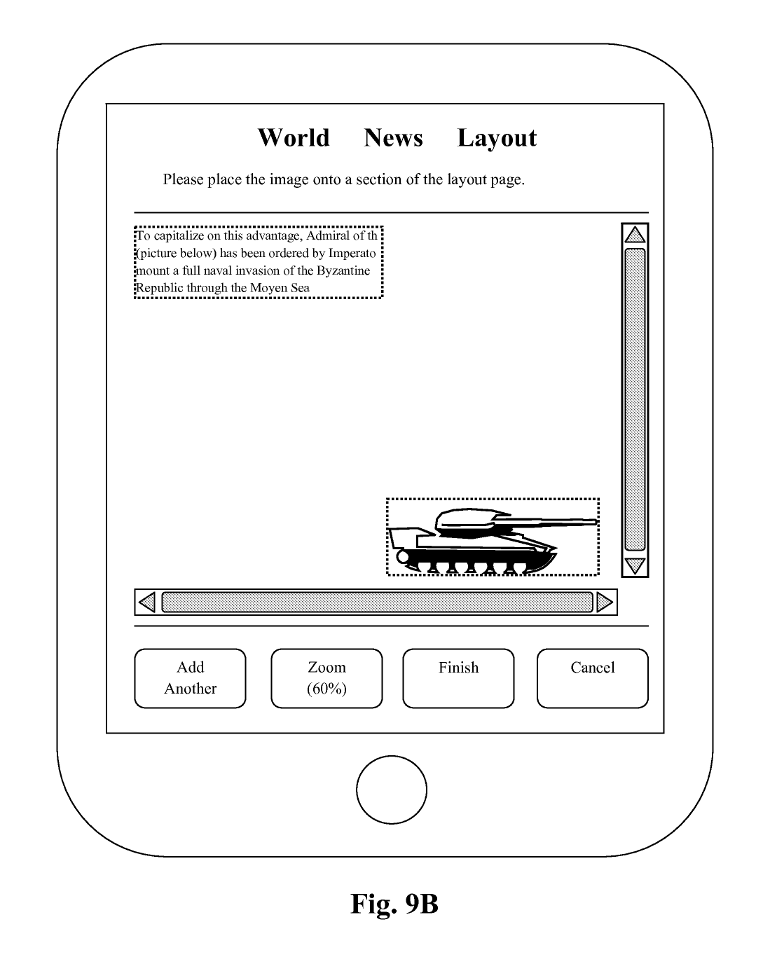

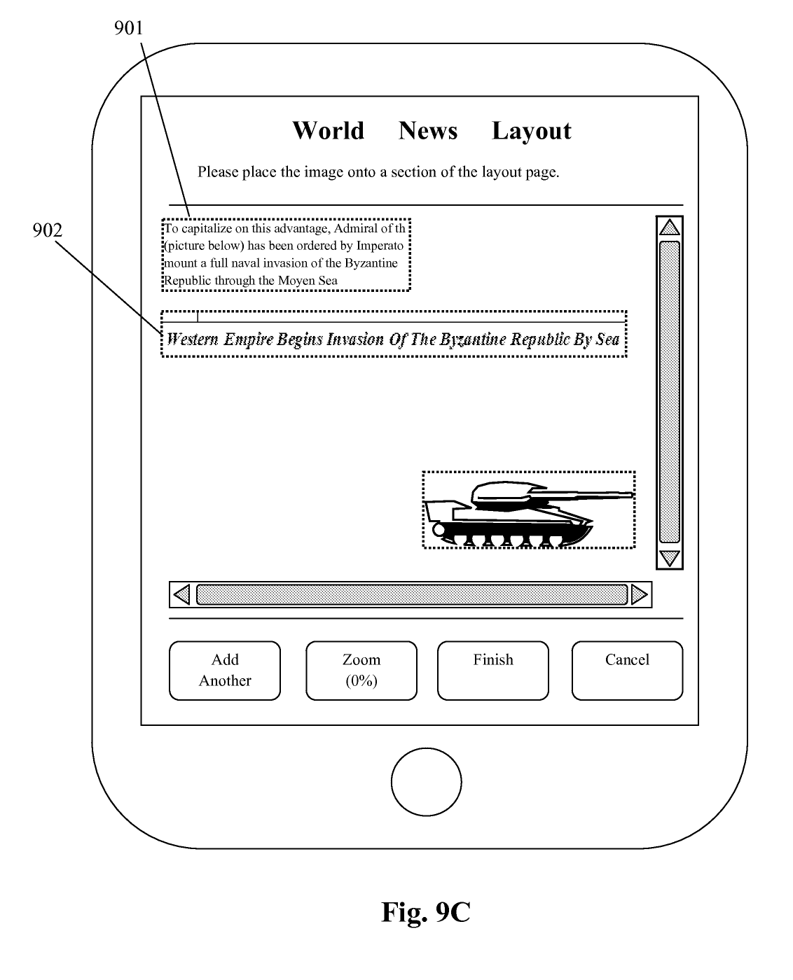

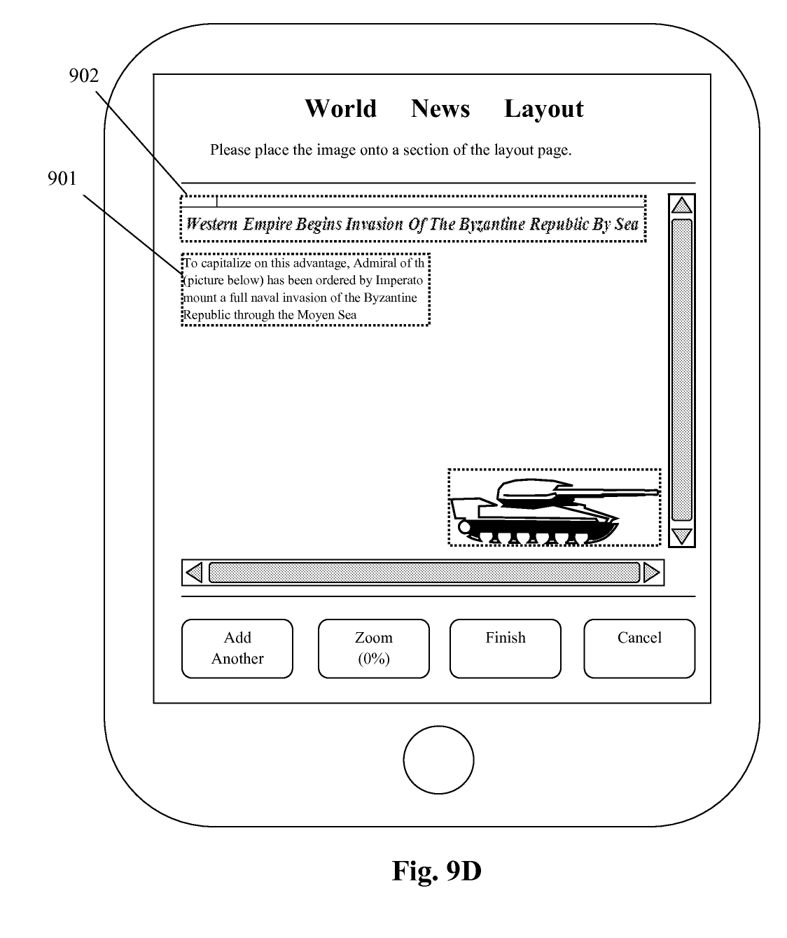

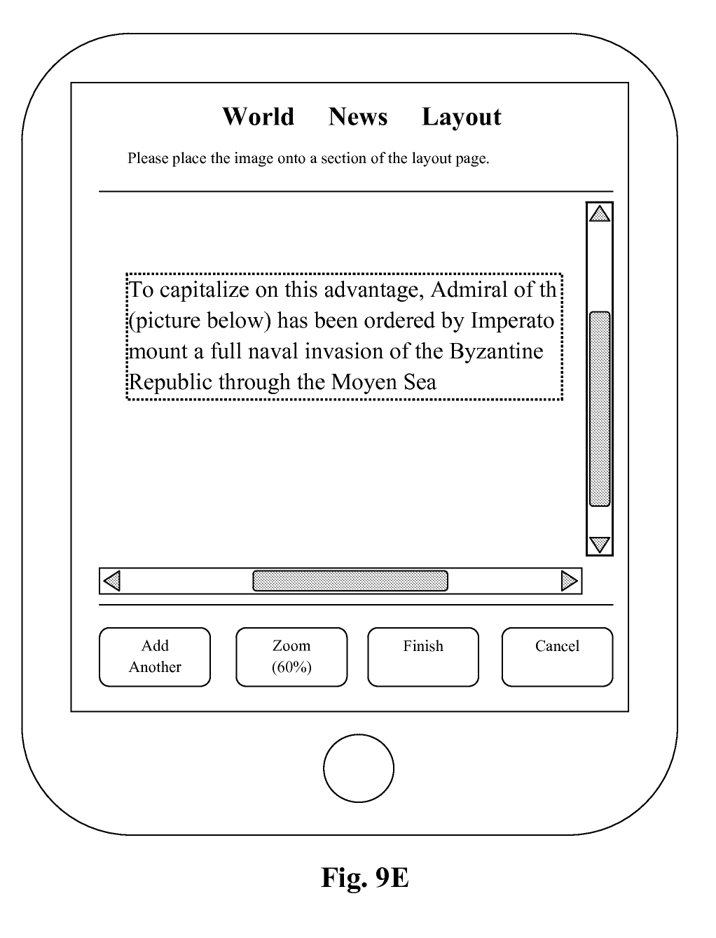

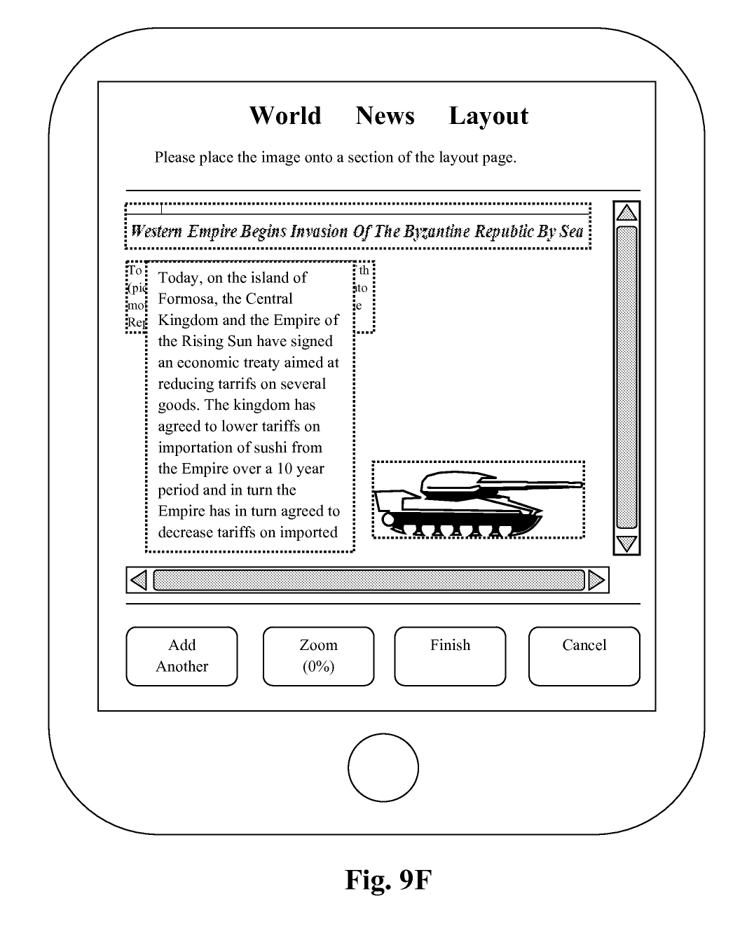

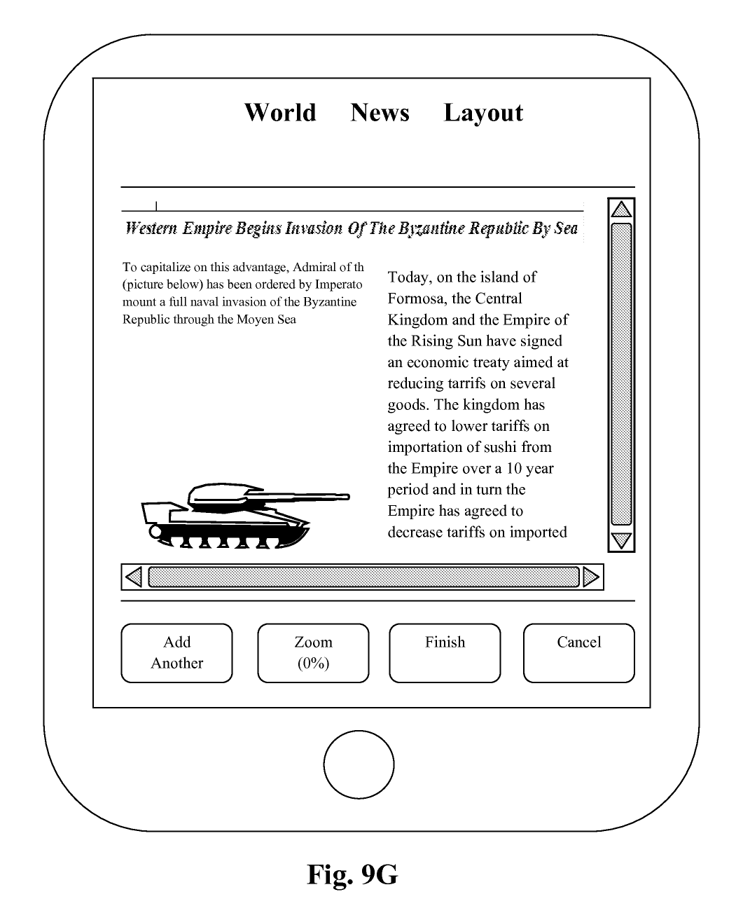

On the other hand, in the case that there is at least one captured content page portion that is already on the layout page (step S803 yes), the mobile terminal apparatus 101 may place the captured content page portion onto an empty area on the layout page (step S808). As shown in FIG. 9B, the captured content page portion containing a part of the news article (first captured content page portion) that was previously selected by the user is on the top left corner of the layout page while the second captured content page portion, which is an image of a tank, is placed at any empty area on the layout page. In addition, it should be noted that the location of the second captured content page portion may also depend on what type of content, such as text or images (jpeg, bmp, png, tiff, etc), is in the captured content page portion. For example, the mobile terminal 101 or the user may have set that any captured content page portion containing text is to be placed in the top left corner of the layout page, while any captured content page portion that is or contains an image is to be at the bottom right corner of the layout page. This is illustrated in FIG. 9B where the second captured content page portion (an image) is placed at bottom right corner of the layout page. It should be noted that conventionally, the second captured content page portion may be placed superimposed on the first content portion or next to it.

After the user has placed at least one captured content page portion onto the layout page, the mobile terminal apparatus 101 may place a frame around it (step S805) as indicated by the dotted line shown in FIG. 9A which allows the user to authorize the mobile terminal apparatus 101 to manipulate and/or resize the frame (step S807). It should be noted that this frame is considered to be a second frame that is distinct from the first frame previously shown in FIGS. 7D-7F. The first frame is used for capturing portions of content obtained from a network. The second frame, on the other hand, is used for resizing or moving the captured content page portion on the layout page. Further, the mobile terminal apparatus 101 may make the size of the second frame equal to the size of the first frame. In this case, the second frame is illustrated by the dotted line outlining the captured content page portions. However, like the first frame, the second frame does not have to necessarily be a black-colored dotted line as it can be colored solid line as well.

For example, as shown in FIG. 9C, the user has placed another captured content page portion onto the layout page. Now there are two captured content page portions (captured content page portion 901 and captured content page portion 902) that contain text from the article previously shown in FIG. 7C. The captured content page portion 901 includes a piece of the article while captured content page portion 902 contains the headline of the article. However, because the captured content page portion 902 was placed in the layout page after the captured content page portion 901, it is placed at empty location, which is in this case is right below the captured content page portion 901. However, the user may desire to place the captured content page portion 902 above the captured content page portion 901, instead, for better organizing. Thus, the user may move the two captured content page portions around to facilitate this as shown by FIG. 9D. As a result, the

In addition to being allowed to move the image, the user may also increase or decrease the size of the captured content page portions. For example, the captured content page portion shown in FIG. 9A may be too small for the user to view or the user may want to make the captured content page portion larger for emphasis. The user can perform this task by adjusting the frame surrounding the captured content portion. Similar to how the user adjusted the frame for capturing the content page portion as previously illustrated in FIG. 7E, the user can move the captured content page portion frame in the same manner. For example, by dragging the right portion of the frame, the user can increase its width. Further, by increasing the overall size of the captured content page portion, the mobile apparatus 101 may simultaneously increase the size or font of the text as shown in FIG. 9E. There may be many ways by which the size of the text is increased. For example, the captured content page portion may contain text, but it may be captured as an image. Thus, when increasing the size of the frame, the image is also increased correspondingly.

On the other hand, the captured content page portion may be copied as text. In another case, an image containing text may be converted via optical character recognition (OCR) to produce a text captured content page portion. Regardless of how the text captured content page portion is obtained, when the mobile terminal apparatus 101 receives an instruction from the user to increase the size of the text captured content page portion, it also increases the font size of the text correspondingly. The font size may be increased until there is no empty space left within the captured content page portion. For example, the font size may be initially at size 12. When the user increases the size of the captured content page portion, the mobile terminal apparatus increases the font size to 16 which causes the text to take up any available space. By the same token, the user may also decrease the size of the captured content portion which also causes the font size of the text to decrease correspondingly.

It should be noted that when the user inserts a captured content page portion into a layout page that contains an empty area that is smaller than the area of the captured content page portion, the mobile terminal apparatus 101 places it on predetermined location superimposed on the other captured content page portions, as shown in FIG. 9F.

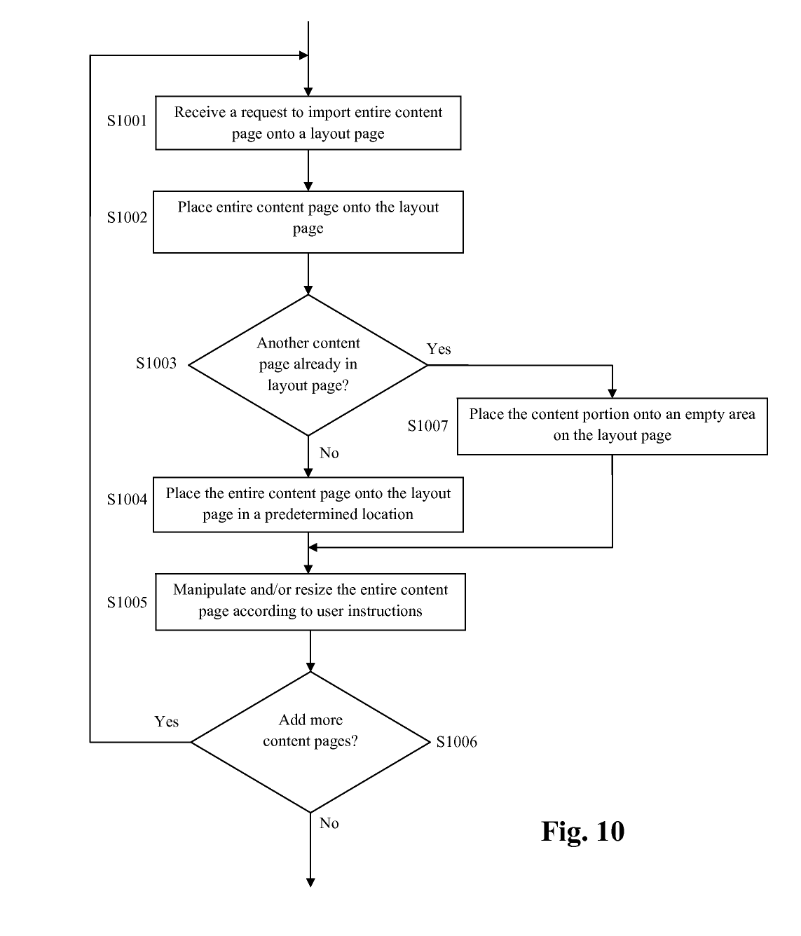

FIG. 10 shows a process performed by a mobile terminal apparatus (e.g., 101), for executing a print layout tool, according to an exemplary embodiment.

As shown in the previously, the user can capture a portion of a content page from a number of sources and place them together on a single layout page. However, the user may also have the option of capturing an entire content page as well. In this case, when the user places the content page on the layout page, he or she may designate a size of the window for displaying the entire content page. Consequently, the user may scroll (up, down, left and right) through the window to access every part of the content page. This is advantageous in that the user may be able to view a larger amount of information within a layout page.

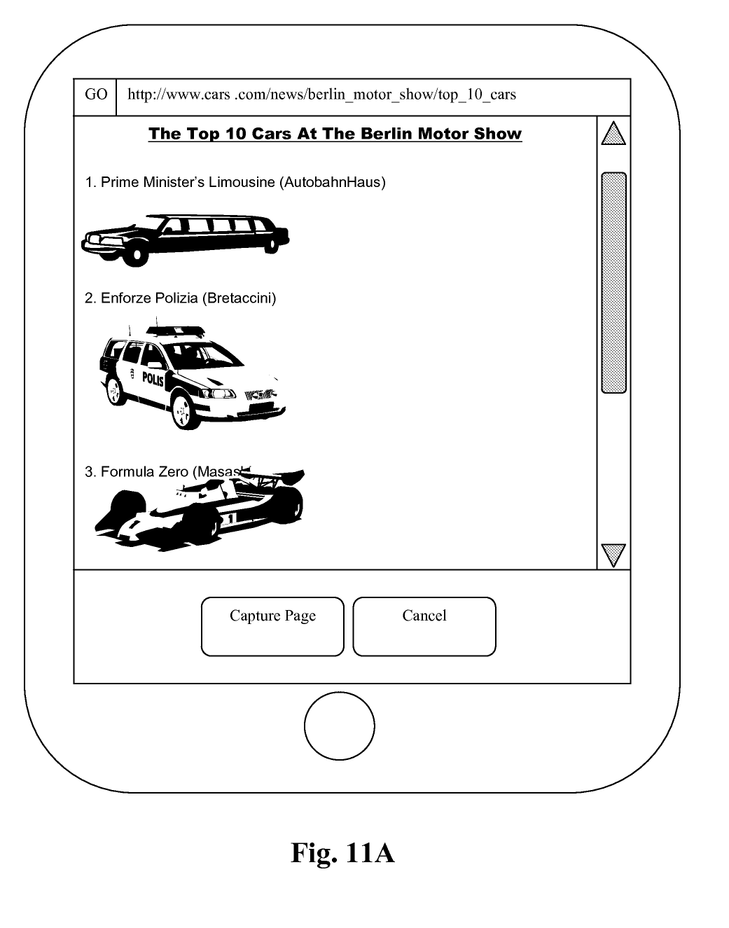

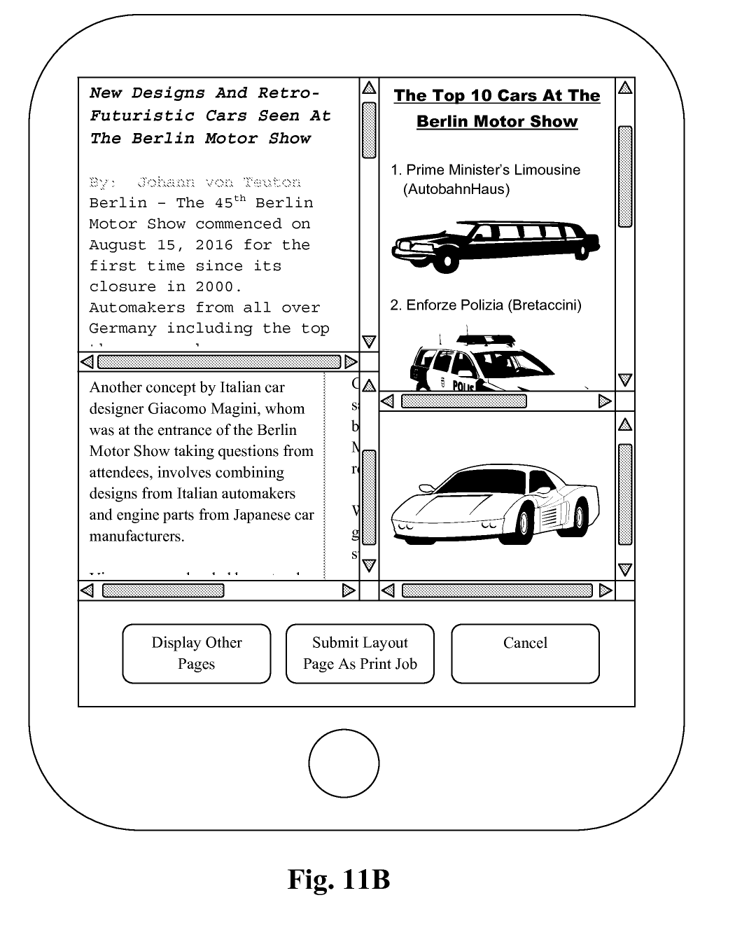

To facilitate this, like previously, the user firsts navigates through a network and then selects content from the network to be placed on a layout page. As shown in FIG. 11A, the user is currently viewing a website which displays a number of cars along with their name, manufacturer and image. In this case, the user wishes to place the entire list of cars within a layout page. To perform this task, the user clicks on the “Capture Page” button which instructs the mobile terminal apparatus 101 to capture the entire content page and import it into a layout page (step S1001). Next, the mobile terminal apparatus 101 attempts to place the entire content page onto a layout page (step S1002).

Then the mobile terminal apparatus 101 performs a determination if there is at least one existing content page on the layout page (step S1003). In the case that there is none (step S1003, no), the mobile terminal apparatus 101 places the entire content page onto a predetermined position (step S1004). This predetermined position may be initially set by the mobile terminal apparatus 101 or the user. In the case that there is at least one existing content page (step S1003, yes), the mobile terminal apparatus 101 places the entire content page onto an empty area on the layout page (step S1007). It should be noted that the entire content pages on the layout page are now windows displaying only a portion of the content. Further, each window includes scrolling icons that allows the user to scroll through each of the entire content pages. Thus, while the user may only view a portion of the content at a time, he or she may still have the ability to view everything in the entire content page.

After the mobile terminal apparatus 101 has placed the entire content page on to the layout page, the user can now instruct the mobile terminal apparatus 101 to manipulate each window containing the entire content page. The windows also contain frames which allow the user to increase or decrease the size of each window. Further, the user may also move the windows or swap them with each other. After the user is finished with manipulating each window, the mobile terminal apparatus 101 may make a determination on whether the user wises to add more content pages to the layout page (step S1006). In the case that the user wants to add more content pages (step S1006, yes), the process is repeated. On the other hand, in the case that the user is finished (step S1006, no), the mobile terminal apparatus 101 may save the layout page onto memory.

An example of a complete layout page is shown in FIG. 11B. As can be seen, there are four windows within the layout page with each representing the entire content page of a source. Thus, the user may utilize the scroll icons to view the entire content page.

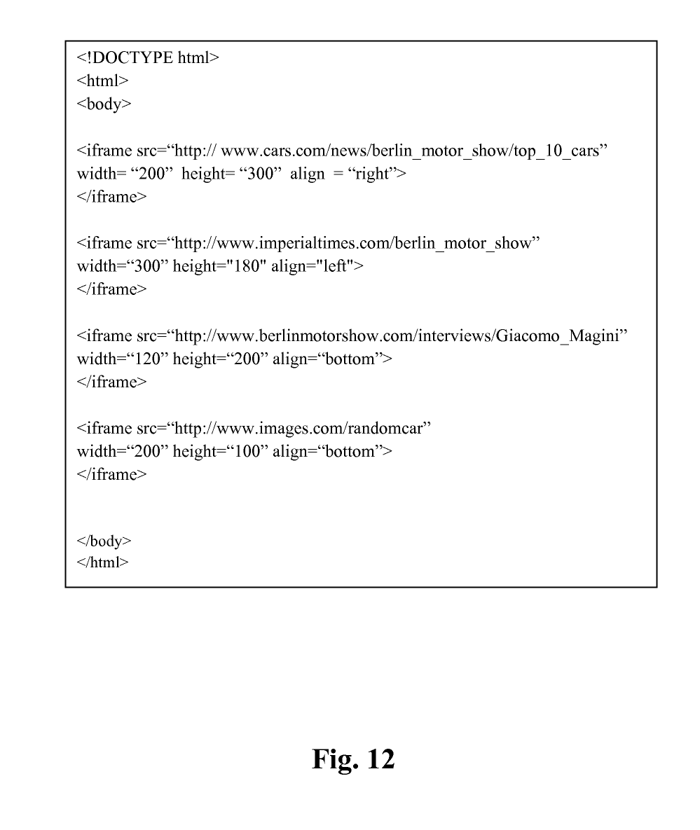

FIG. 12 is an example of HTML code that may be used to facilitate the placement of the content portions on the layout page. As shown, the HTML code corresponds to FIG. 11B and mainly uses the “iFrame” tag to facilitate the placement of the content page. Each “iFrame” tag requires for its syntax the source address (i.e. http://www.example.com) and allows users to modify the height, width and alignment of each content page. It should be noted that may be other tag besides the “iFrame” tag. For example, there may be a “paragraph” tag (<p>). Further, these tags may also determine the location of the content page portions. For example the mobile terminal apparatus 101 may place a content page portion with an “iFrame” tag at the bottom right corner of the layout page, while a content page portion with a “paragraph” tag may be placed at the top right corner of the layout page instead.

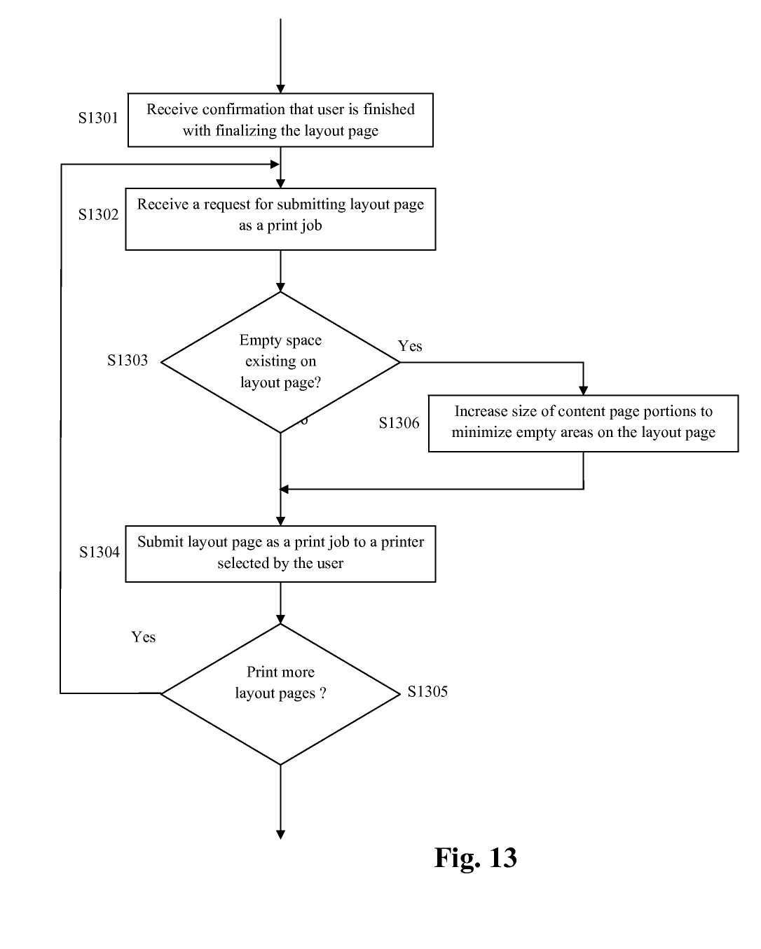

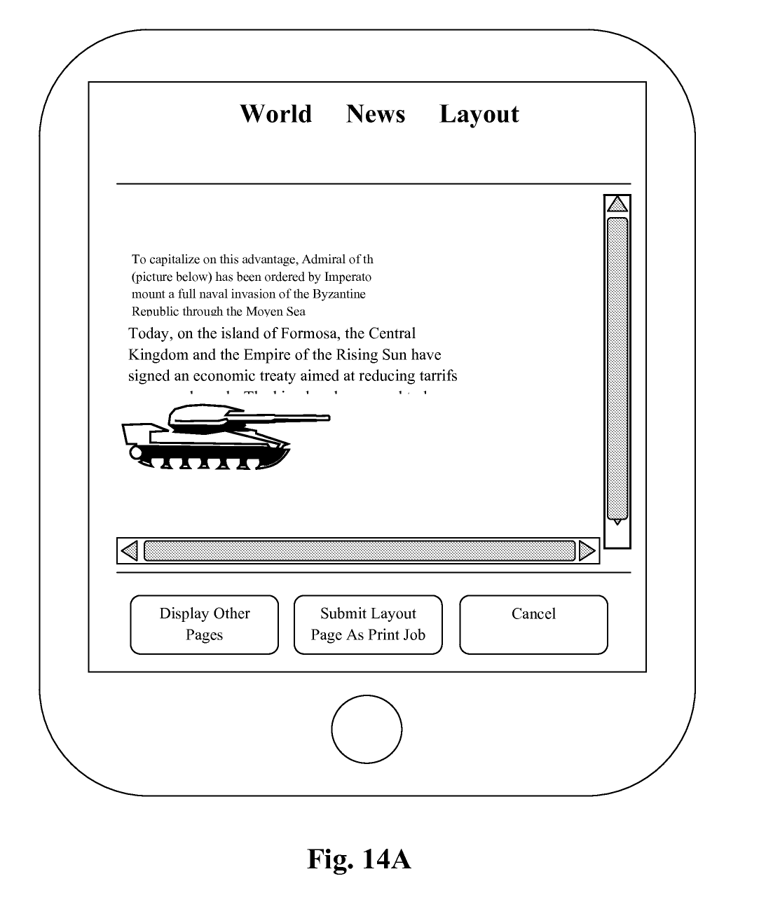

FIG. 13 shows a process performed by a mobile terminal apparatus (e.g., 101), for executing a print layout tool, according to an exemplary embodiment.

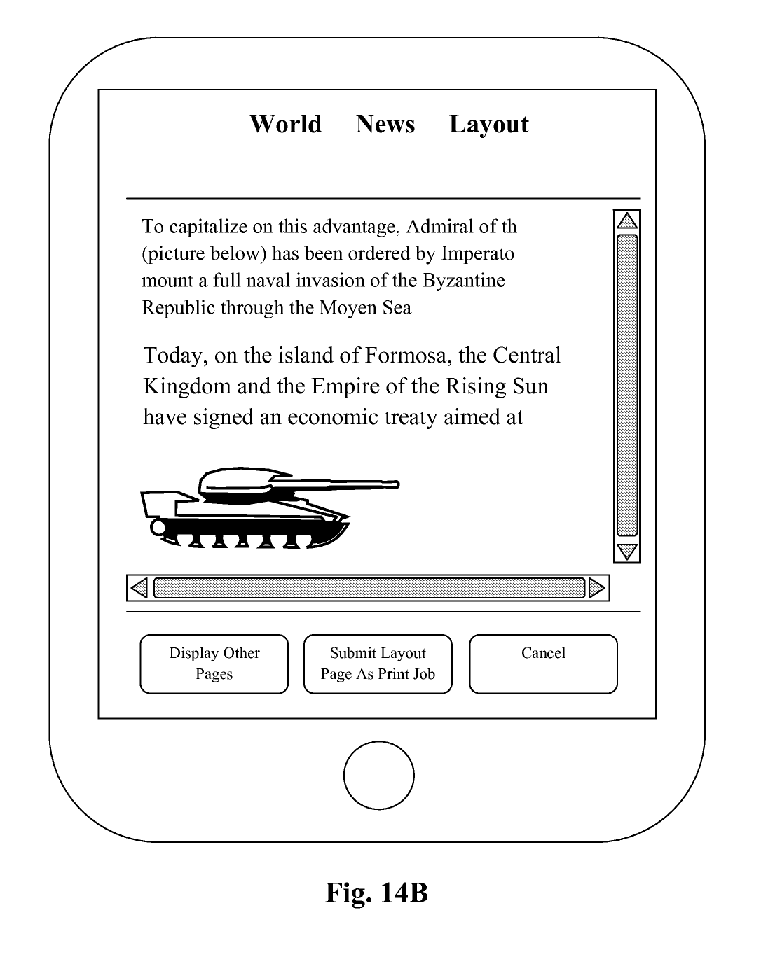

After the user has finished creating at least one layout page containing at least one content portion, the user may be allowed to print the layout page as a print job. When the mobile terminal apparatus 101 confirms that the user has finished finalizing the layout page (step S1301), it displays a screen to the user such as the one illustrated in FIG. 14A. As shown, the user has placed three content page portions onto a layout page. However, it should be noted that they do not take up the entire area of the layout page. In addition, the screen also displays a “Submit Layout Page As Print Job” button which allows the user to submit the current layout page to a printer or an MFP for printing.

When the mobile terminal apparatus 101 receives a request from the user to print the layout page (step S1302), it may make a determination if there are any empty areas that are on the layout page (step S1303). These areas are spaces that are unused by any content page portion. As discussed and shown previously in FIG. 14A, the content page portions, in this case, only take up a part of the layout page leaving a large amount of unused portions. Consequently, the mobile terminal apparatus 101 may enlarge each content page portion to use up these unused portions. This results in the screen illustrated in FIG. 14B. As shown, each content page portion is enlarged by the mobile terminal apparatus 101 to a size that would minimize the amount of empty spaces within the layout page.

It should be noted that there may be many ways by which each content page portion is enlarged. For example, one method may be enlarging every content page portion equally. Another method may include selectively enlarging a content page portion based on a variety of factors. For example, the mobile terminal apparatus 101 may only increase the size of content page portions that contain text while leaving the content page portions that are images the same size or vice versa.

Thus, in a case that there are empty spaces in the layout page (step S1303, yes), the mobile terminal apparatus 101 may increase the size of the content page portions to minimize unused portions on the layout page (step S1306). Otherwise, in the case that the content page portions cannot be enlarged or the user selects not to perform enlargement, the mobile terminal apparatus 101 proceeds to submitting the layout page to a printer selected by the user (step S1304). Next, after successfully sending the layout page to the printer, the mobile terminal apparatus 101 determines whether the user wants to continue printing other layout pages stored in memory (step S1305). In the case that the user wishes to continue printing (step S1305, yes), the process is repeated. Otherwise, the mobile terminal apparatus 101 terminates the process (step S1305, no).

The orders in which the steps are performed in the aforementioned methods are not limited to those shown in the examples of FIGS. 6, 8 and 10, and may be switched as long as similar results are achieved. Also, it should be noted that the methods illustrated in the examples of FIGS. 6, 8 and 10 may be implemented using any of the systems described in connection with FIGS. 2A and 2B.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. A mobile terminal apparatus configured to be connected to a network and including a graphical display, a processor and a non-transitory storage medium storing one or more programs of instructions executable by the processor, said programs of instructions, when executed by the processor, configuring the mobile terminal apparatus to comprise:
a content browser that retrieves specified content including at least one of text and images through the network from one or more content sources, and causes the retrieved content to be displayed on the graphical display; and
a layout interface including
a frame content part to receive a user-specified frame command to frame a portion of a content page, wherein the layout interface, in response to the frame command, causes a user-manipulatable frame to be displayed on the graphical display, and the layout interface permits the displayed frame to be moved and to be resized by the user,
a capture part to receive a user-specified capture command to capture the framed content page portion into a capture buffer, and
a place content part to receive a user-specified place command to retrieve the captured content page portion from the capture buffer and place the captured content page portion onto a layout page in progress.

2. The mobile terminal apparatus of claim 1, wherein the captured content page portion is placed by the layout interface onto the layout page in progress with another user-manipulatable frame surrounding the placed content page portion, and the layout interface permits said another frame surrounding the placed content page portion to be moved and to be resized by the user.

3. The mobile terminal apparatus of claim 2, wherein when the user resizes said another frame surrounding the placed content page portion, text in the content page portion surrounded by said another frame is correspondingly resized as well.

4. The mobile terminal apparatus of claim 2, wherein said another frame surrounding the placed content page portion is a same size as that of the user-manipulatable frame surrounding the content page portion when the content page portion was captured.

5. The mobile terminal apparatus of claim 1, wherein the layout interface further includes a job submit part to receive a user-specified submit command to finalize the layout page in progress and submit the finalized page as a print job.

6. The mobile terminal apparatus of claim 5, wherein when the job submit part receives the user-specified submit command to finalize the layout page in progress, the layout interface automatically resizes content page portions placed on the layout page in progress to minimize an unused portion of the layout page in progress, the unused portion having no content placed therein.

7. The mobile terminal apparatus of claim 1, wherein when the place content part receives the user-specified place command to place another captured content page portion onto the layout page in progress, the layout interface automatically determines an unused portion of the layout page in progress, the unused portion having no content placed therein, and the layout interface places said another content page portion in said unused portion of the layout page in progress.

8. The mobile terminal apparatus of claim 1, wherein when the frame content part receives the user-specified frame command, the layout interface determines a size of the user-manipulatable frame and a location to place the frame on the graphical display, based on tags in the content page.

9. The mobile terminal apparatus of claim 1, wherein when the frame content part receives the user-specified frame command, the layout interface determines a size of the user-manipulatable frame and a location to place the frame on the graphical display, based on the content in the content page.

10. A print layout application including one or more programs of instructions embodied in a non-transitory computer readable medium and executable by a processor of a mobile terminal apparatus,
wherein the print layout application when executed by the processor comprises a layout interface including
a frame content part to receive a user-specified frame command to frame a portion of a content page including at least one of text and images received through the network from one or more content sources, wherein the layout interface, in response to the frame command, causes a user-manipulatable frame to be displayed on the graphical display, and the layout interface permits the displayed frame to be moved and to be resized by the user,
a capture part to receive a user-specified capture command to capture the framed content page portion into a capture buffer, and
a place content part to receive a user-specified place command to retrieve the captured content page portion from the capture buffer and place the captured content page portion onto a layout page in progress.

11. The print layout application of claim 9, wherein the captured content page portion is placed by the layout interface onto the layout page in progress with another user-manipulatable frame surrounding the placed content page portion, and the layout interface permits said another frame surrounding the placed content page portion to be moved and to be resized by the user.

12. The print layout application of claim 10, wherein when the user resizes said another frame surrounding the placed content page portion, text in the content page portion surrounded by said another frame is correspondingly resized as well.

13. The print layout application of claim 10, wherein said another frame surrounding the placed content page portion is a same size as that of the user-manipulatable frame surrounding the content page portion when the content page portion was captured.

14. The print layout application of claim 9, wherein the layout interface further includes a job submit part to receive a user-specified submit command to finalize the layout page in progress and submit the finalized page as a print job.

15. The print layout application of claim 13, wherein when the job submit part receives the user-specified submit command to finalize the layout page in progress, the layout interface automatically resizes content page portions placed on the layout page in progress to minimize an unused portion of the layout page in progress, the unused portion having no content placed therein.

16. The print layout application of claim 9, wherein when the place content part receives the user-specified place command to place another captured content page portion onto the layout page in progress, the layout interface automatically determines an unused portion of the layout page in progress, the unused portion having no content placed therein, and the layout interface places said another content page portion in said unused portion of the layout page in progress.

17. The print layout application of claim 9, wherein when the frame content part receives the user-specified frame command, the layout interface determines a size of the user-manipulatable frame and a location to place the frame on the graphical display, based on tags in the content page.

18. The print layout application of claim 9, wherein when the frame content part receives the user-specified frame command, the layout interface determines a size of the user-manipulatable frame and a location to place the frame on the graphical display, based on the content in the content page.

19. A non-transitory computer readable medium embodying a program of instructions executable by a processor of a mobile apparatus to perform a print layout method comprising:
providing a layout interface including a frame content part to receive a user-specified frame command to frame a portion of a content page;
causing a user-manipulatable frame to be displayed, in response to the frame command, and providing handles on the displayed frame for the user to move and to resize the frame;
receiving a user-specified capture command and capturing the framed content page portion into a capture buffer;
receiving a user-specified place command, and retrieving the captured content page portion from the capture buffer and placing the captured content page portion onto a layout page in progress with another user-manipulatable frame surrounding the placed content page portion; and
providing handles on said another frame surrounding the placed content page portion to permit said another frame surrounding the placed content page portion to be moved and to be resized by the user.
